(19) United States
(12) Patent Application Publication
(10) Pub. No.: US 2025/0227021 A1
(43) Pub. Date: Jul. 10, 2025

(54) Rapid Network Redundancy Failover

(71) Applicant: ADTRAN, Inc., Huntsville, AL (US)

(72) Inventors: Kyle Platts, Huntsville, AL (US); Camila Jersonsky, Huntsville, AL (US); Darrin L. Gieger, Huntsville, AL (US); Andrew T. Ruble, Huntsville, AL (US); Abhijeet Shirgurkar, Huntsville, AL (US)

(21) Appl. No.: 18/718,020

(22) PCT Filed: Nov. 7, 2022
(86) PCT No.: PCT/US2022/049104

§ 371 Date: Jun. 8, 2024

Related U.S. Application Data
(60) Provisional application No. 63/288,403, filed on Dec. 10, 2021.

(51) Int. Cl. H04L 41/0663; H04L 43/0817

(52) U.S. Cl. CPC H04L 41/0663; H04L 43/0817

(57) ABSTRACT

Methods and systems for high speed failover in a network are provided. To provide faster Type C GPON redundancy failover, the disclosure herein describes the use of G.8031 1:1 ELPS in a single ended application to ensure path integrity through the network. Single ended 1:1 ELPS means that a network device is configured with 1:1 ELPS and switches paths in the event of disruption of the working communication path without the other underlying transport entities having knowledge of either the ELPS protocol or state machine. ELPS (Ethernet Linear Protection Switching, ITU G.8031) is a standardized method for protection switching between two point-to-point paths through a network, however its application here is quite novel. During a failure on the working path, traffic will switch over to the protection path. Type C PON protection provides a fully redundant path between the OLT and the ONU (2 separate PONs).

### BACKGROUND

Access data networks which have nodes and links that are located outside of facilities which provide high availability power and protection against physical accidents and other means of causing failure of network components are fundamentally less reliable than similar networks in which nodes and links are contained within more secure and reliable facilities. These access networks connect hosts to core networks which employ sophisticated routing protocols and redundant connectivity to ensure that the network has high availability. Connectivity to the high-reliability core network is via one or more gateway nodes at the edge of that core network. To improve the availability of connections of end-hosts connected via access networks to the core network, a primary and secondary gateway node are often designated, with the access network providing connectivity paths to both. Mechanisms to select which gateway node is active at a given time exist, and the gateway nodes involved employ protocols such as Virtual Router Redundancy Protocol (VRRP) and Multi-Chassis LAG (ML-LAG) and other similar protocols to select which gateway node is the active connection point for a given end-host. These mechanisms require support of these protocols by the gateway nodes, which communicate between each other to determine which node is currently active. The nature of these protocols provide a minimum time required to change the active gateway host, and during this time, the end-host is not connected to the core network and this minimum time may be in excess of end-user application requirements. In order to avoid the requirement of these protocols for selecting the active gateway node, it is desired to have a mechanism to connect end-hosts to the core network which doesn't require the gateway nodes to select the active access node connection point, as well as not requiring any special functionality in the access network to support it.

A common architecture for access network employs Passive Optical Network (PON) technologies, such Gigabit PON (GPON) and 10-Ggabit symmetric PON (XGS-PON). PON-based architecture employ an access node containing the PON Optical Line Terminal (OLT) and an Optical Network Unit (ONU) (sometimes referred to as an Optical Network Termination, or ONT) at the customer location. High availability methods are defined for the Passive Optical Network (PON) technologies. These mechanisms are defined in ITU-T G.984 (GPON) and ITU-T G.9807 (XGS-PON) and similar documents and discussed further in ITU-T G.sup51. As described in ITU-T G.984.1, redundancy methods defined at the PON layer only protect the PON portion of the access network rather than the full path between the end-host and the gateway node(s). Type B protection is defined to use multiple OLTs but only a single ONT per subscriber. As a result, in involves considerable complexity to achieve rapid switchover, requiring that the primary and secondary OLTs coordinate their provisioning and operational states (e.g. connected ONTs, ranging information, etc.) so that this information doesn't have to be rediscovered during the switchover interval. This typically limits the speed at which network switching takes place. Type C protection avoids these complexities by using separate ONU/ONTs for the primary and secondary paths, allowing the OLT-ONT relationship to be constant across a switchover event.

The ITU-T supplements G.sup51 and G.sup54 additionally describe the use of Ethernet Linear Protection Switching (ELPS) to protect the path between a network Ethernet switch and the splitter (Type B redundancy). Note that while a similar approach could be applied to Type-C redundancy, unlike the VRRP and MC-LAG approaches described above, the network-based switching element is a single device and represents a single point of failure, reducing the value of the protection switching mechanism. A method to realize Type C protection but avoid the single point of failure in the network Ethernet switch is clearly desired.

### SUMMARY

The mechanism defined here achieves the above mentioned goals by pushing the responsibility for gateway node selection to a newly introduced protection switch edge node which sits beyond the access network, typically deployed on the end customer side of a conventional access network (e.g. customer side of the Optical Network Unit (ONU) or Optical Network Termination (ONT)). This node provides a mechanism to connect to two independent access networks, each with a primary connection point to the core network as shown in FIG. 7. The protection switch edge node employs primary and secondary network ports for access network connectivity as well as one or more “customer facing” ports for end-hosts to connect to it. The protection switch edge node is configured to detect faults in the network paths between its primary and secondary ports, which are connected to the primary and secondary access networks, and the primary and secondary core network gateway nodes, respectively, one for each access network. The fault detection mechanism is frequently transmitting packets with the peer management endpoint function in each gateway node (primary and secondary), at a rate fast enough to ensure that the selection mechanism can meet the network switching times required by the end-host application(s). Upon detection of a fault condition in the primary path, the protection switch edge node switches the end-host connectivity to the secondary path, changing the the gateway node that the end-host is connected to. The gateway nodes respond to the presence of the packets arriving from the host on the secondary node by updating their forwarding tables, as per normal operation for standard L2 nodes (e.g. Ethernet switches.) In doing so, the speed at which the network responds to an outage in the access network is largely a function of the the frequency at which the end-host or protection switch edge nodes send out packets over the non-management path, allowing the network availability to be both higher and under the control of the newly invented protection switch edge node and the applications which run on the end-host.

Relative to the VRRP and MC-LAG approaches, this new methodology moves the functionality for selecting primary and secondary gateway nodes to each protection switch edge node and does not require coordination between the gateway nodes and protection switch edge nodes for selection (outside of fault detection) and does not require coordination between the gateway nodes. By only requiring a network maintenance entity group end point (e.g., MEP) on the gateway nodes, and no changes to the access nodes, this functionality can be added to virtually any network, simply by deploying redundant access networks. These redundant access networks may be configured to improve reliability by using separate physical paths from each end-node to the gateway nodes, though this is not required if only equipment redundancy (vs. full path redundancy) is desired. Furthermore, this mechanism allows the functionality to be added to networks where the gateway nodes do not employ mechanisms for choosing the active gateway node using protocols that require communication between the gateway nodes. The lack of dependence on such protocols extends the applicability of this mechanism to many deployment scenarios where the current method are excluded due to the functionality of existing deployed networks. With the new invention, the decision for which gateway node is active is not made by the gateway nodes, but rather by the newly invented protection switch edge node, allowing both faster switch over, and connectivity to gateway nodes which do not employ specialized protocols to select the active node. In doing so, such a mechanism will move the decision for choosing the gateway node for each end-host to a network device which performs this function for one or a few end-hosts that are located within a short physical proximity of each other. By pushing the decision to the edge of the access network, high-availability access to the core network is possible without employing complex protocols on the gateway nodes or the access network, which is between the protection switch edge node and the gateway nodes.

There are many possible implementations of the above described invention, the detailed description of the invention will use the context of an access network employing Passive Optical Network (PON) technologies such as Gigabit PON (GPON) and 10-Ggabit symmetric PON (XGS-PON), but that should not be construed as limit the scope of the invention as it should be obvious to anyone skilled in the art that the applicability of the new method does not employ any protocol or mechanism that is specific to any PON protocol or technology. Furthermore, the fault-detection protocol described employs Y.1731 Ethernet management protocols and peered point-to-point management paths, but that again should not be construed as a limiting implementation of the invention. Furthermore, the protection switching mechanism of the newly invented protection switch edge node is described as a modification of the ITU-T G.8031 Ethernet Linear Protection Switch (ELPS) protocol, a protocol that is defined to operate between peer nodes, with multiple paths of connectivity between them. The state machines defined in G.8031 assume a peer node at the far end. In our implementation, we employ a slightly modified ELPS state machine at only the protection switch edge node, and do not have a L2 peer node making similar decisions using the ELPS state machine or other similar mechanism. Therefore we refer to this newly defined mechanism as “Single-Ended ELPS”, but that should not be construed as limiting other implementations of the invention which do not employ a modified version of the ELPS state machine.

Additionally, once a protection switch event has been restored (e.g. the fault on the primary path has been repaired), the traffic may switch back to the primary path, or the traffic may remain on the secondary path. The path that is carrying traffic is typically called the active path, and the path that is not carrying traffic is typically called the standby path. Working and protection are other equivalent terms that can be used in place of primary and secondary.

In one embodiment, this specification relates to fast Type C GPON redundancy failover in a network. Type C PON provides protection between two aggregation switches and a CPE with two GPON uplinks to two distinct PONs (passive optical networks). To achieve desirable failover speeds the specification describes a novel use of ITU G.8031 1:1 ELPS (Ethernet Linear Protection Switching) in a single ended application to ensure path integrity through the network. ELPS is a standardized method for protection switching between two point-to-point paths through a network. During a failure on the working path, traffic will switch over to the protection path. In single ended 1:1 ELPS, a network device is configured with 1:1 ELPS and switches paths in the event of disruption of a working communication path. Fault detection and failover occurs without other underlying communication paths having knowledge of either the ELPS protocol or state machine.

A network may comprise multiple aggregation switches, multiple OLTs, and multiple CPEs (customer-premises equipment).

The disclosure herein describes solutions that leverage local decision making of ELPS path selection, without using a coordinated endpoint. The ELPS state machine is simplified in its operation because it does not coordinate with the opposite endpoint as defined by ITU-T G.8031. Moving the path decision making to the CPE allows for each individual CPE to make a determination as to the available path to use. This determination is done autonomously in the CPE without the need for additional user or software intervention. These changes are needed because G.8031 Standard 1:1 ELPS introduces a single point of failure, which is undesirable. For instance, the selector and bridge are coordinated between endpoints using state machines. APS packets are sent on the protect path and CCMs (continuity check messages) run on each path to determine path state.

For purposes of this disclosure, a communication path extends between an aggregation switch and a CPE. An aggregation switch generates CCMs and delineates the boundary of the ELPS protection domain. Network fault detection occurs through transmission of multiple Ethernet OAM (operations, administration and maintenance) CCMs per second, allowing for fast path failure detection. As one example, transmitting Ethernet OAM CCMs at 3.3 ms intervals allows path failure detection within approximately 11 ms according to the disclosure herein. RDI (remote defect indication) is used to determine path integrity and can detect unidirectional failures.

In event of path failure detection, if the path that has failed is currently being used as the active path, the ELPS state machine forces a failover to the standby path, if it is valid. Each CPE has its own MEG. Upstream traffic from the CPE to the aggregation switch moves over as soon as the ELPS state machine changes the path. Upon ELPS failover, the CPE shall send a gratuitous ARP (address resolution protocol) message to ensure management traffic fails over. The aggregation switch learns the MAC (media access control) address on the new port and allows downstream management (e.g. control) traffic to flow.

The disclosure herein scales across any number of CPEs and is limited only by the Ethernet OAM generation rate of the aggregation switches. Thus, the solutions provided herein horizontally scale by using multiple aggregation switches.

There are many advantages of the solutions described in this disclosure. For instance the solutions provide rapid switching between working and protect paths upon detection of a network failure and reduces single point of failure in the network. The solutions require no participation from the OLTs in the communication paths and thereby reduce complexity, command and control traffic, processing latency, and the like. Likewise, no additional or unique protocols are needed to maintain the ELPS state machines for the ELPS protection groups. In addition, this solution allows for redundancy of OLT and ONU equipment, whereas previous disclosures provided redundancy of only the OLT. For instance, the solutions described herein provide geographic redundancy of the network equipment and provide two fully redundant OLT and ONU links. Moreover, this solution does not unnecessarily failover paths that are not in the fault state. Instead, each CPE is free to failover individually and independently of the other CPEs on the same PON.

As one of skill in the art will appreciate, the solutions described herein combine several protocols and functions into a single novel solution that provides horizontally scalable resilient transport agnostic path protection.

In general, one innovative aspect of the subject matter described in this specification can be embodied in methods that include the actions of establishing a working communication path between an aggregation switch and a CPE, wherein the working communication path communicatively traverses an OLT and wherein a MEP of the aggregation switch is communicatively coupled with a MEP of the CPE; establishing a protection communication path between the aggregation switch or a second aggregation switch and the CPE, wherein the protection communication path traverses a second OLT and wherein a second MEP of the aggregation switch or the second aggregation switch is communicatively coupled with a second MEP of the CPE; wherein the CPEs transmit and receive data on the working communication path and monitor the protection communication path in a non-fault state; detecting a network fault on the working communication path based on non-responsiveness of the MEP of the aggregation switch or the MEP of the CPE; and responding to the network fault on the working communication path by promoting, at the aggregation switch, the protection communication path to an active state. Other embodiments of this aspect include corresponding systems, apparatus, and computer programs, configured to perform the actions of the methods, encoded on computer storage devices.

These and other embodiments can each optionally include one or more of the following features. Detecting a network fault on the working communication path based on non-responsiveness of the MEP of the aggregation switch or the MEP of the CPE can include monitoring the working communication path using continuity check messages generated by the MEP of the aggregation switch.

The continuity check messages can include status information about a local port and a physical interface.

The MEP of the aggregation switch can send an RDI notification to the CPE based on a determination that the aggregation switch has detected a communication fault in the working communication path.

A communication path can exist between each physical interface of aggregation switch and the OLT element.

Promoting, at the aggregation switch, the protection communication path can include switching upstream traffic from the CPE to the aggregation switch from the working communication path to the protection communication path; learning a MAC address of a port coupled to the protection path at the CPE; and sending downstream traffic from the aggregation switch to the port at the CPE.

Method can include sending, by the CPE, a gratuitous ARP containing IP address and MAC address information.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example network architecture.

FIG. 2 illustrates an example network architecture with an ONU communication fault.

FIG. 3 illustrates an example network architecture with a PON communication fault.

FIG. 4 illustrates an example network architecture with an OLT fault.

FIG. 5 provides a flow chart for fault detection and failover.

FIG. 6 provides a flow chart for fault detection and failover.

FIG. 7 illustrates an example network architecture.

Like reference numbers and designations in the various drawings indicate like elements.

### DETAILED DESCRIPTION

Methods and systems for Rapid Type C GPON Redundancy Failover are discussed throughout this document. As will be discussed in more detail with reference to the figures, redundant communication paths exist between a CPE and a network. Network access is via one or more aggregation switches. These redundant communication paths can be viewed as an ELPS protection group whose connectivity is protected from network failures through the use of a unique form of Single Ended 1:1 ELPS processing. Unlike traditional ELPS processing, only one endpoint is directly involved in fault detection and there is no coordination between the two endpoints using APS messages. The network fault detection and rapid failover scheme described herein also decouples the control and data planes. The solution separates the control and data planes such that the control plane is monitored using the unique Single Ended 1:1 ELPS while the data plane uses ELAN resiliency. Thus, as is disclosed herein, the network can individually or collectively control failover, as appropriate. As one example, CCMs associated with one VLAN could detect network faults causing failovers in different VLANs.

Per ELPS, between two network entities, traffic traverses one of two paths: a working path or a protection path. A given path has two states: active or standby. These two paths and their associated traffic and services, running on VLANs, form an ELPS (Ethernet linear protection switching) group. In normal operation, the traffic and services will traverse the working path, as it is active while the protection path is standby. However, in a fault state, the ELPS group fails over from the active working path such that its traffic and services now traverse the newly active protection path. The ELPS group may revert the active path to the working path when the failure has been corrected, however this is not required.

As described in the standard, G.8031 1:1 ELPS uses selectors and bridges at upstream and downstream network elements (EAST and WEST endpoints) that are coordinated using state machines tracking the active and standby status of the working transport entity (TE) and the protection transport entity (TE). To detect faults on the working and protection TEs, CCM traffic is sent over both paths. When a fault is detected, APS packets are sent on the protection TE. For clarity, the term working TE and working path refer to the same element, and the term protection TE and protection path refer to the same element.

G.8031 can be advantageously modified by replacing the selector and bridge at the WEST endpoint with an Ethernet switch. CCM messages are communicated on each of the working and protect paths to monitor path health. CCM endpoints detect network faults and determine the path fault domain. The Ethernet switch generates CCM messages on the working and the protect paths that will inform the CPE of their status and integrity, and ultimately allow it to make a decision as to which path to use. The EAST endpoints then choose which of the working or protect path should be designated the active path. Among the ports assigned to the working and protect paths, the active port of the WEST Ethernet switch is determined to be that port with a MAC address known to the system (e.g., through ARP tables, IP to MAC address mappings, etc.). Unlike G.8031 defined in the standard, no APS packets are used. In other words, this solution can be implemented independent of APS packets.

In one implementation, the CPEs only transmit and receive on the active path while monitoring both paths using CCMs. The aggregation switches are agnostic to the ELPS group. However, the aggregation switches contain MEPs to generate CCMs to each CPE. The CPEs make the decision as to which path to use based on the CCMs received from the switch, and trigger path changes in the ELPS state machine accordingly. For instance, the absence of received CCM traffic on a MEP of the CPE indicates a network fault on that communication path. On failover, the aggregation switches relearn the traffic MAC addresses on the newly active path as the traffic starts to flow through it, such as through ARP messaging for management or through upstream data packets. Accordingly, rapid fault detection and failover can occur in many embodiments.

Because the WEST endpoint does not use the ELPS protocol or state machine, it's functionality can be split between multiple aggregation switches, providing additional redundancy.

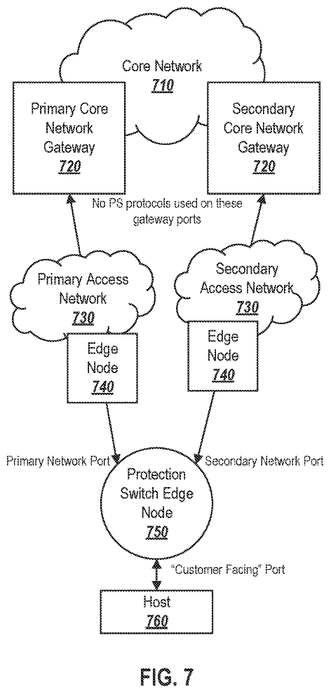

As shown in FIG. 7, in some implementations, the network comprises a core network 710 and access networks 730. The core network 710 connects to access networks 730 through network gateways 720. Network edge nodes 740 connect the access networks 730 to a protection switch edge node 750. A host 760 connects to the networks 710, 730 through the protection switch edge node 750.

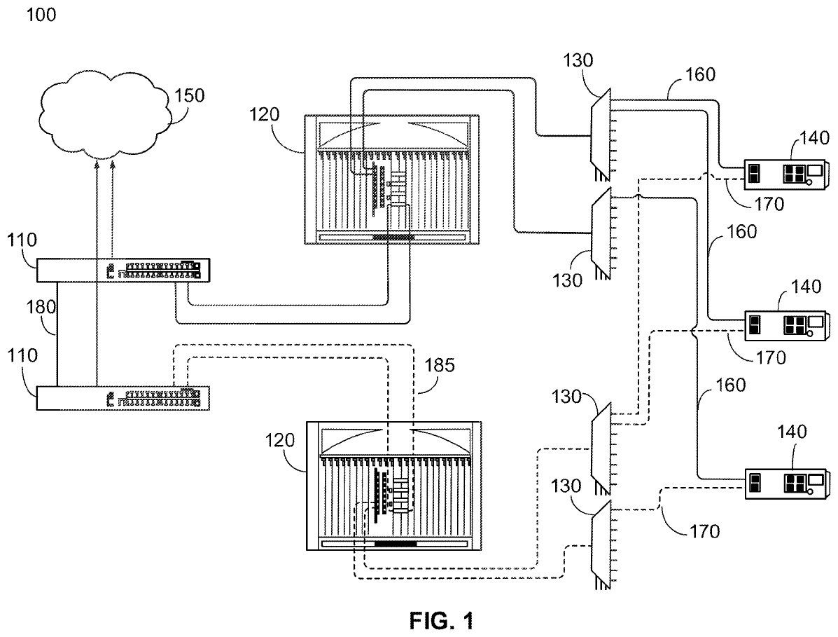

As shown in FIG. 1, in some implementations, the network 100 comprises aggregation switches 110, OLTs 120, optical signal splitters 130, and CPEs 140 that are communicatively connected. A data plane VLAN connects an aggregation switch 110 to an uplink 150 to CPE 140 through both OLTs 120 and both aggregation switches 110. A control plane VLAN connects an aggregation switch 110 to the CPE 140 through one OLT 120. The CPEs 140 transmit and receive on a working (e.g., active) path 160 while monitoring both the working path 160 and a protect path 170. In some implementations, the working path 160 and the protect path 170 need not be the same across CPEs 140. For instance, a CPE 140 can have the working path 160 to an OLT 120 and the protect path 170 to a different OLT 120, whereas another CPE 140 may use the paths differently. Whether a path is working or protect is relevant to one CPE, individually; the system may be configured either way. As described, the aggregation switches 110 are unaware of the ELPS protection groups (e.g., the combination of working path 160 and protection path 170). The aggregation switches 110 contain MEPs to generate CCMs that are transmitted to each CPE 140. Each CPE 140 has the control logic executed, for example, by one or more processors or other data processing apparatus, to detect network faults and determine whether to use the working path 160 or the protection path 170 as the active path and whether a failover is necessary because the working path can no longer communicate due to a network fault. In the event failover is necessary, protection path 170 becomes the active path and working path 160 becomes the standby path. Aggregation switches 110 learn all of the CPE 140 MAC addresses on active paths (e.g., the working path 160) and send traffic on the data VLAN. If a failover occurs, the aggregation switches 110 relearn the MAC address of all communication paths subject to the failover (e.g., the protection path 170 made active).

Still with respect to FIG. 1, in a no-fault state, all CPEs 140 transmit and receive data on the active (e.g. working) path 160. Any data received by a CPE 140 on the standby (e.g., protect) path 170 is discarded. CPEs 140 do not actively listen for data on the standby path 170. In a no-fault state, the CCMs are transmitted and received on the working path 160 and protect paths 170 (e.g., active and standby paths) that connect each aggregation switch 110 with every CPE 140. No CCMs or control plane traffic passes from one aggregation switch 110 to the other aggregation switch 110. CCMs do not traverse aggregation switches 110.

Still with respect to FIG. 1, in a no-fault state, peer-to-peer (P2P) communications (e.g., communications originating at one CPE and destined for one or more other CPEs) are received at the OLT 120 from the CPE 140 on the active path 160. For unicast P2P traffic, the OLT 120 locally switches the traffic. For multicast P2P traffic, the OLT 120 multicasts the P2P traffic to CPEs 140 on its shelf (e.g., to CPEs coupled to it on working paths 160) and to the aggregation switch 110. The aggregation switches 110 pass the P2P multicast traffic on the data VLAN between the working path 160 and protect path 170. The P2P multicast traffic then traverses the protect paths 170 to the CPEs 140 but is discarded at the CPEs 140 because they do not listen for data on the standby path 170.

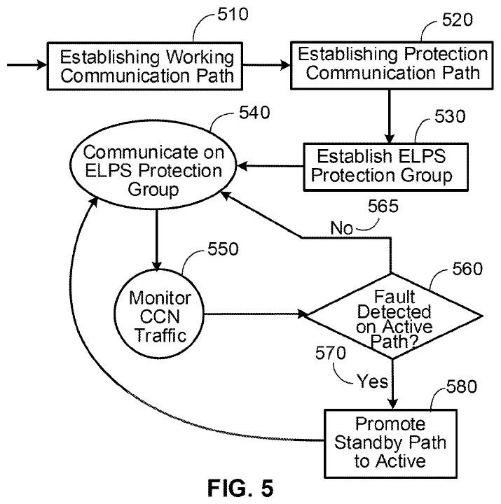

FIG. 5 illustrates generally how communication paths are established and fault detection and failover occurs. A working communication path is established 510, and a protection communication path is established 520. The working communication path can be established between an aggregation switch and a CPE, and can communicatively traverse an OLT. A MEP of the aggregation switch can be communicatively coupled with a MEP of the CPE by the working communication path. The protection communication path can be established between the aggregation switch or a second aggregation switch and the CPE, and can communicatively traverse a second OLT. A second MEP of the aggregation switch or the second aggregation switch can be communicatively coupled with a second MEP of the CPE by the protection communication path. In a non-fault state, CPEs transmit and receive data on the working communication path and monitor the working and protection communication paths.

An ELPS protection group is established 530 comprising the working path and the protection path. Communication proceeds over the ELPS protection group 540. As communication proceeds over the ELPS protection group 540, CCM traffic is monitored 550 for fault detection 560. A fault on a working path can be detected 560 based on the absence of CCM traffic at a MEP, of an aggregation switch and/or a CPE device, associated with the working path. For example, if CCM traffic persists, no fault is indicated 565. If CCM traffic is absent, a fault is detected 570. When a fault is detected 570, the aggregation switch and CPE transition to another path (e.g., working or protection). For example, when the aggregation switch detects a loss of continuity (or another communication fault) based on a lack of received CCMs from the CPE (e.g., because of a failed CPE laser), the aggregation switch can send an RDI to the CPE, which can cause the CPE to failover to another path. Additionally, or alternatively, the CPE may send an RDI notification to the aggregation switch over the protect path. RDI notifications can be sent over either the working or the protect path, depending on which has the fault. When a fault is detected 570 on the working path, the protection path is promoted to an active state and becomes the active path for that ELPS protection group 580. Communications continue on that ELPS protection group 540 and CCM traffic continues to be monitored 550. For instance, once the protection path is made active, the CPE switches upstream traffic to the aggregation switch from the working communication path to the protection communication path. For downstream traffic, the aggregation switches learn a MAC address of a port coupled to the active path at the CPE. The aggregation switches may learn this MAC address by sending a gratuitous ARP message. The CPE sends a gratuitous ARP for the aggregation switch to learn its management MAC address. Upstream traffic flowing through the CPE causes the aggregation switch to learn other MAC addresses. Once the MAC address of the port coupled to the active path at the CPE is learned, the aggregation switches send downstream traffic on the active path to the port at the CPE.

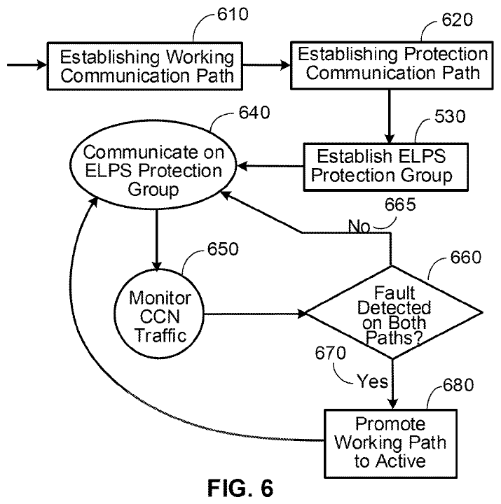

FIG. 6 illustrates generally how communication paths are established and fault detection and failover occurs when a fault is detected on both the active and the standby paths. A working communication path is established 610, and a protection communication path is established 620. The working communication path can be established between an aggregation switch and a CPE, and can communicatively traverse an OLT. A MEP of the aggregation switch can be communicatively coupled with a MEP of the CPE by the working communication path. The protection communication path can be established between the aggregation switch or a second aggregation switch and the CPE, and can communicatively traverse a second OLT. A second MEP of the aggregation switch or the second aggregation switch can be communicatively coupled with a second MEP of the CPE by the protection communication path. In a non-fault state, CPEs transmit and receive data on the working communication path and monitor the working and protection communication paths.

An ELPS protection group is established 630 comprising the working path and the protection path. Communication proceeds over the ELPS protection group 640. As communication proceeds over the ELPS protection group 640, CCM traffic is monitored 650 for fault detection 560. A fault on both the active and the standby paths can be detected 660 based on the absence of CCM traffic at a MEP, of a CPE device, associated with the working path. For example, if CCM traffic persists, no fault is indicated 665. If CCM traffic is absent, a fault is detected 670. When a fault is detected 670, the CPE may send an RDI notification to the aggregation switch over the protect path. RDI notifications can be sent over either the working or the protect path, depending on which has the fault. When a fault is detected 670 on both the active and the standby paths, the working path is promoted to an active state and becomes the active path for that ELPS protection group 680. Communications continue on that ELPS protection group 640 and CCM traffic continues to be monitored 650. For instance, once the protection path is made active, the CPE switches upstream traffic to the aggregation switch from the working communication path to the protection communication path. For downstream traffic, the aggregation switches learn a MAC address of a port coupled to the active path at the CPE. The aggregation switches may learn this MAC address by sending a gratuitous ARP message. The CPE sends a gratuitous ARP for the aggregation switch to learn its management MAC address. Upstream traffic flowing through the CPE causes the aggregation switch to learn other MAC addresses. Once the MAC address of the port coupled to the active path at the CPE is learned, the aggregation switches send downstream traffic on the active path to the port at the CPE.

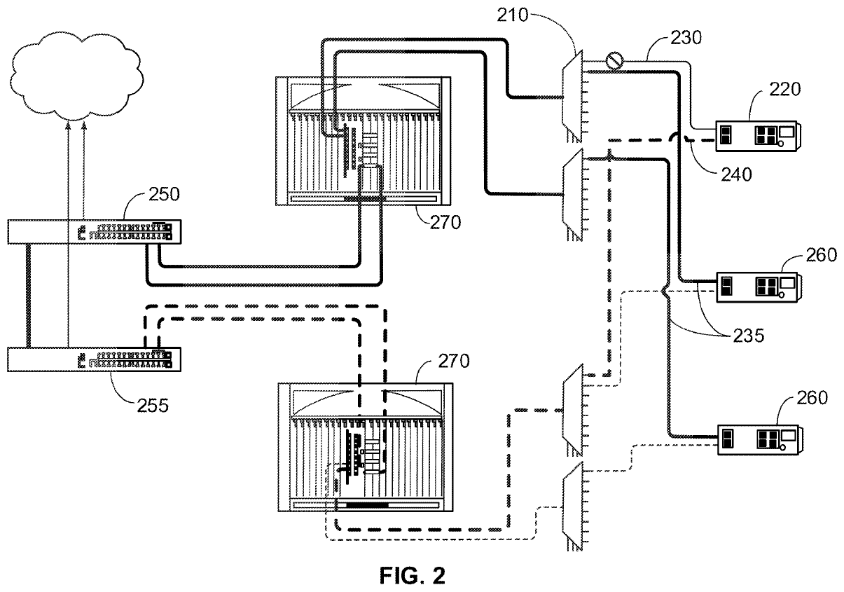

As shown in FIG. 2, in a fault state where an optical signal splitter 210 loses connection with a CPE 220 (e.g., due to a fiber cut or other error), the CPE 220 recognizes that CCM traffic is down on an working path 230 (e.g., due to a lack of data being received over the working path 230), declares the active path 230 down (e.g., as having a fault), and fails over to the protect path 240 (e.g., by making the protect path 240 the active path). The aggregation switches 250, 255 learn (e.g., obtain) the MAC address of the CPE 220 interface on the newly designated active path 240. For P2P communications in such a fault state, the affected CPE 220 declares the working (e.g., active) path 230 down and starts transmitting and listening for data on the protect path 240 only (e.g., the active path after failover). As a result, the affected CPE 220 now receives the P2P traffic on the protect path 240. For unaffected CPEs 260, the active path 235 remains intact and these CPEs 260 continue to transmit and listen for data on the active path 235 only. The OLTs 270 continue to operate without regard for the fault condition. The aggregation switches 250, 255 continue to pass the P2P multicast traffic on the data VLAN between the working and the protect paths. The aggregation switches 250, 255 learn the MAC address of the interface terminating the new active path 240 at the affected CPE 220 and forward unicast P2P traffic to the affected CPE 220 on the new active path 240. For other network communications in this fault state, the aggregation switches 250, 255 continue to pass network traffic to unaffected CPEs 260 on the data VLAN. The aggregation switch 255 terminating the newly active path 240 learns the MAC address upstream traffic through CPE 220 terminating the newly active path 240. The CPE 220 has a management MAC address, but other traffic is flowing through the CPE 220. All of this traffic has different MAC source addresses. Aggregation switches 250, 255 learn all of these MAC addresses. The aggregation switch 250 terminating the faulty active path no longer passes network traffic on the faulty path 230.

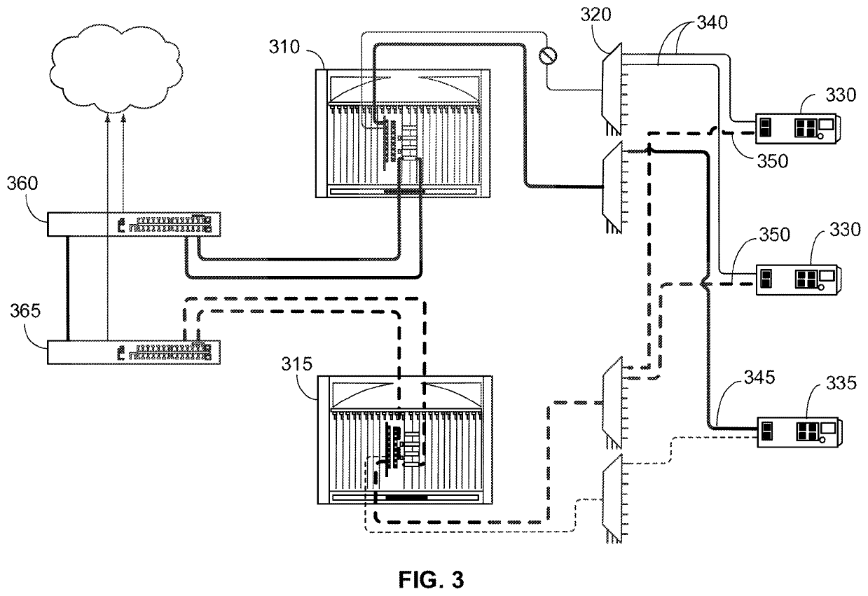

As shown in FIG. 3, in a fault state where the OLT 310 loses connection with an optical splitter 320 (e.g., due to a cable cut between the OLT 310 and the optical splitter 320), this affects all CPEs 330 with active paths 340 traversing the optical splitter 320. The affected CPEs 330 recognize that CCM traffic is down on these affected active paths 340, declare the affected active paths 340 down, and fail over (e.g., by making the protect paths 350 the new active paths). The aggregation switches 360, 365 learn the MAC addresses of the CPE 330 interfaces on the newly designated active paths 350. For P2P communications in such a fault state, the affected CPEs 330 declare the working (e.g., active) paths 340 down and start transmitting and listening for data on the protect paths 350 only (e.g., the active paths after failover). As a result, the affected CPEs 330 now receive the P2P traffic on their protect paths 350. For unaffected CPEs 335, the active path 345 remains intact and these CPEs 335 continue to transmit and listen for data on the active path 345 only. The OLTs 310, 315 continue to operate without regard for the fault condition. The aggregation switches 360, 365 continue to pass the P2P multicast traffic on the data VLAN between the working and the protect paths. The aggregation switches 360, 365 learn the MAC addresses of interfaces terminating the new active paths 350 at the affected CPEs 330 and forward unicast P2P traffic to the affected CPEs 330 on the new active paths 350. For other network communications in this fault state, the aggregation switches 360, 365 continue to pass network traffic to unaffected CPEs 330 on the data VLAN. The aggregation switch 365 terminating the newly active paths 350 learns the MAC addresses of upstream traffic through CPEs 330 terminating the newly active paths 350. The aggregation switch 360 terminating the faulty active paths 340 no longer passes network traffic on the faulty active paths 340.

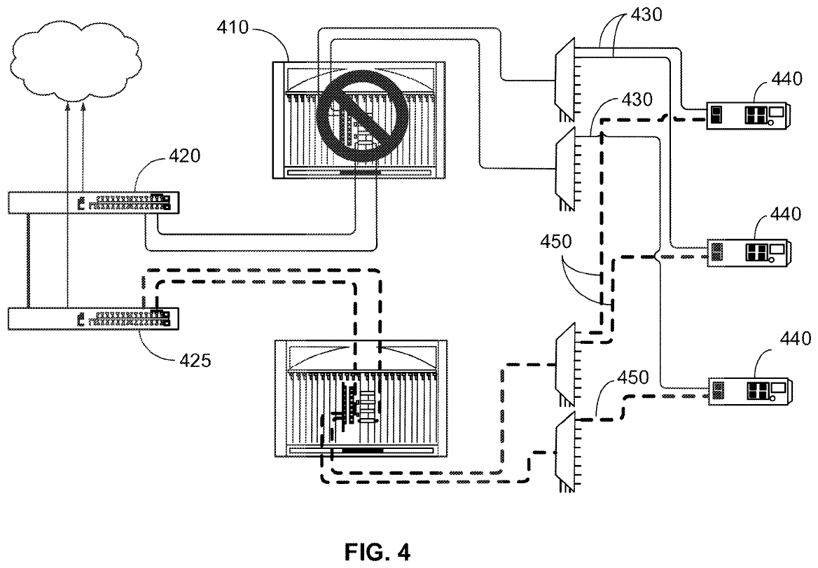

As shown in FIG. 4, in a fault state where an OLT 410 or an aggregation switch 420 fails, the CCMs are down for all communication paths 430 connecting the CPEs 440 to the failed equipment 410. The affected CPEs 440 declare the affected active paths 430 down and failover to standby paths 450 (e.g., protect paths). The unaffected aggregation switch 425 learns the MAC addresses of the CPE 440 interfaces on the newly designated active paths 450. For P2P communications in such a fault state, the affected CPEs 440 declare the working (e.g., active) path 430 down and start transmitting and listening for data on the protect (e.g., the active paths after failover) paths 450 only. As a result, the affected CPEs 440 now receive the P2P traffic on their protect paths 450. For other network communications in this fault state, the aggregation switches 420, 425 continue to pass network traffic to unaffected CPEs on the data VLAN. The aggregation switch 425 terminating the newly active paths 450 learns the MAC addresses of the physical interfaces of the CPEs 440 terminating the newly active paths 450. The aggregation switch 420 terminating the faulty active paths 430 no longer passes network traffic on the faulty active paths 430.

CPE (customer-premises equipment) generally refers to devices such as telephones, routers, network switches, residential gateways, set-top boxes, fixed mobile convergence products, home networking adapters and Internet access gateways that enable consumers to access communication providers' services and distribute them in a residence or business over a local area network.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products, or a single hardware product or multiple hardware products, or any combination thereof.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The operations described in this specification can be implemented as operations performed by a data processing apparatus on data stored on one or more computer-readable storage devices (e.g., one or more non-transitory computer-readable mediums) or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

What is claimed is:

1-10. (canceled)

11. A method of communication resilience in a network, comprising:
establishing a working communication path between an aggregation switch and a CPE, wherein the working communication path communicatively traverses an OLT and wherein a MEP of the aggregation switch is communicatively coupled with a MEP of the CPE;
establishing a protection communication path between the aggregation switch or a second aggregation switch and the CPE, wherein the protection communication path traverses a second OLT and wherein a second MEP of the aggregation switch or the second aggregation switch is communicatively coupled with a second MEP of the CPE;
wherein the CPEs transmit and receive data on the working communication path and monitor the protection communication path in a non-fault state;
detecting a network fault on the working communication path based on non-responsiveness of the MEP of the aggregation switch or the MEP of the CPE; and
responding to the network fault on the working communication path by promoting, at the aggregation switch, the protection communication path to an active state.

12. The method of claim 11, wherein detecting a network fault on the working communication path based on non-responsiveness of the MEP of the aggregation switch or the MEP of the CPE further comprises monitoring the working communication path using continuity check messages generated by the MEP of the aggregation switch.

13. The method claim 12, wherein the continuity check messages include status information about a local port and a physical interface.

14. The method of claim 11, wherein the MEP of the aggregation switch sends an RDI notification to the CPE based on a determination that the aggregation switch has detected a communication fault in the working communication path.

15. The method of claim 11, wherein a communication path exists between each physical interface of aggregation switch and the OLT.

16. The method of claim 11, wherein promoting, at the aggregation switch, the protection communication path comprises:
switching upstream traffic from the CPE to the aggregation switch from the working communication path to the protection communication path;
learning a MAC address of a port coupled to the protection path at the CPE; and
sending downstream traffic from the aggregation switch to the port at the CPE.

17. The method of claim 11 further comprising sending, by the CPE, a gratuitous ARP containing IP address and MAC address information.

18. A system comprising:
an aggregation switch;
a maintenance entity group end point (“MEP”) communicatively coupled to the aggregation switch, wherein the system is configured to execute instructions that cause the system to perform operations comprising:
establishing a working communication path between an aggregation switch and a CPE, wherein the working communication path communicatively traverses an OLT and wherein a MEP of the aggregation switch is communicatively coupled with a MEP of the CPE;
establishing a protection communication path between the aggregation switch or a second aggregation switch and the CPE, wherein the protection communication path traverses a second OLT and wherein a second MEP of the aggregation switch or the second aggregation switch is communicatively coupled with a second MEP of the CPE;
wherein the CPEs transmit and receive data on the working communication path and monitor the protection communication path in a non-fault state;
detecting a network fault on the working communication path based on non-responsiveness of the MEP of the aggregation switch or the MEP of the CPE; and
responding to the network fault on the working communication path by promoting, at the aggregation switch, the protection communication path to an active state.

19. The system of claim 18, wherein detecting a network fault on the working communication path based on non-responsiveness of the MEP of the aggregation switch or the MEP of the CPE further comprises monitoring the working communication path using continuity check messages generated by the MEP of the aggregation switch.

20. The system claim 19, wherein the continuity check messages include status information about a local port and a physical interface.

21. The system of claim 18, wherein the MEP of the aggregation switch is configured to send an RDI notification to the CPE based on a determination that the aggregation switch has detected a communication fault in the working communication path.

22. The system of claim 18, wherein a communication path exists between each physical interface of aggregation switch and the OLT.

23. The system of claim 18, wherein promoting, at the aggregation switch, the protection communication path comprises:
switching upstream traffic from the CPE to the aggregation switch from the working communication path to the protection communication path;
learning a MAC address of a port coupled to the protection path at the CPE; and
sending downstream traffic from the aggregation switch to the port at the CPE.

24. The system of claim 18, wherein the instructions cause the system to perform operations further comprising sending, by the CPE, a gratuitous ARP containing IP address and MAC address information.

25. A non-transitory computer readable medium storing instructions that, upon execution by one or more data processing apparatus, cause the one or more data processing apparatus to perform operations comprising:
establishing a working communication path between an aggregation switch and a CPE, wherein the working communication path communicatively traverses an OLT and wherein a MEP of the aggregation switch is communicatively coupled with a MEP of the CPE;
establishing a protection communication path between the aggregation switch or a second aggregation switch and the CPE, wherein the protection communication path traverses a second OLT and wherein a second MEP of the aggregation switch or the second aggregation switch is communicatively coupled with a second MEP of the CPE;
wherein the CPEs transmit and receive data on the working communication path and monitor the protection communication path in a non-fault state;
detecting a network fault on the working communication path based on non-responsiveness of the MEP of the aggregation switch or the MEP of the CPE; and
responding to the network fault on the working communication path by promoting, at the aggregation switch, the protection communication path to an active state.

26. The non-transitory computer readable medium of claim 25, wherein detecting a network fault on the working communication path based on non-responsiveness of the MEP of the aggregation switch or the MEP of the CPE further comprises monitoring the working communication path using continuity check messages generated by the MEP of the aggregation switch.

27. The non-transitory computer readable medium claim 26, wherein the continuity check messages include status information about a local port and a physical interface.

28. The non-transitory computer readable medium of claim 25, wherein the instructions cause the MEP of the aggregation switch to send an RDI notification to the CPE based on a determination that the aggregation switch has detected a communication fault in the working communication path.

29. The non-transitory computer readable medium of claim 25, wherein promoting, at the aggregation switch, the protection communication path comprises:
switching upstream traffic from the CPE to the aggregation switch from the working communication path to the protection communication path;
learning a MAC address of a port coupled to the protection path at the CPE; and
sending downstream traffic from the aggregation switch to the port at the CPE.

30. The non-transitory computer readable medium of claim 25, wherein the instructions cause the one or more data processing apparatus to perform operations further comprising sending, by the CPE, a gratuitous ARP containing IP address and MAC address information.
